(19) United States
(12) Patent Application Publication
(10) Pub. No.: US 2015/0170037 A1
(43) Pub. Date: Jun. 18, 2015

(54) SYSTEM AND METHOD FOR IDENTIFYING HISTORIC EVENT ROOT CAUSE AND IMPACT IN A DATA CENTER

(71) Applicant: Vyacheslav Lvin, Mountain View, CA (US)

(72) Inventor: Vyacheslav Lvin, Mountain View, CA (US)

(73) Assignee: Alcatel-Lucent USA Inc., Murray Hill, NJ (US)

(21) Appl. No.: 14/107,375

(22) Filed: Dec. 16, 2013

(51) Int. Cl. G06N 5/04

(52) U.S. Cl. CPC G06N 5/04

(57) ABSTRACT

Systems, methods, architectures and/or apparatus for determining a historic hierarchy of failure relationships associated with a historic event of interest and identifying, for the historic moment in time, higher-level objects/entities within a data center which, when failed, necessarily produce failure of corresponding lower-level objects/entities. This information is especially useful within the context of identifying root cause failures associated with a historic event of interest, as well as the impact of the historic event of interest upon other objects/entities.

### FIELD OF THE INVENTION

The invention relates to the field of network and data center management and, more particularly but not exclusively, to the management and utilization of event data in networks, data centers and the like.

### BACKGROUND

Data Center (DC) architecture generally consists of a large number of compute and storage resources that are interconnected through a scalable Layer-2 or Layer-3 infrastructure. In addition to this networking infrastructure running on hardware devices the DC network includes software networking components (v-switches) running on general purpose compute, and dedicated hardware appliances that supply specific network services such as load balancers, ADCs, firewalls, IPS/IDS systems etc. The DC infrastructure can be owned by an Enterprise or by a service provider (referred as Cloud Service Provider or CSP), and shared by a number of tenants. Compute and storage infrastructure are virtualized in order to allow different tenants to share the same resources. Each tenant can dynamically add/remove resources from the global pool to/from its individual service.

Virtualized services as discussed herein generally describe any type of virtualized compute and/or storage resources capable of being provided to a tenant. Moreover, virtualized services also include access to non-virtual appliances or other devices using virtualized compute/storage resources, data center network infrastructure and so on. The various embodiments are adapted to improve event-related processing within the context of data centers, networks and the like.

Within the context of a typical data center arrangement, a tenant entity such as a bank or other entity has provisioned for it a number of virtual machines (VMs) which are accessed via a Wide Area Network (WAN) using Border Gateway Protocol (BGP). At the same time, thousands of other virtual machines may be provisioned for hundreds or thousands of other tenants. The scale associated data center may be enormous. Thousands of virtual machines may be created and/or destroyed each day per tenant demand.

Each of the virtual ports, virtual machines, virtual switches, virtual switch controllers and other objects or entities within the data center (virtual and otherwise) generates event data in response to many different types of conditions.

All of the events produced by an event-sourcing entity are stored for subsequent use, such as for determining root cause problems associated with events or failures of interest. That is, given an event of interest in the past (e.g., a failure of a virtual entity or object of importance to a customer), the events temporally proximate the failure of interest (e.g., +/−some amount of time) are useful in determining a root cause failure of an event of interest in the past.

However, the various events must be viewed within the context of the real and instantiated structure of the data center at the time of the occurrence of the events. Thus, given that objects/entities within the data structure are constantly changing (instantiated, torn down, migrated, failed, restored etc.), current practice is to store periodic snapshots in time (e.g., every 5 minutes) of the data center structure and use these snapshots to try and identify the root cause failure associated with an event of interest.

Thus, to identify the root cause failure associated with an event of interest the snapshot of the data center structure closest in time to an event of interest is normally used to identify the root cause failure associated with the event of interest. In some systems, the two snapshots of the data center structure temporally bracketing the event of interest may be used to identify the root cause failure associated with the event of interest.

Unfortunately, maintaining snapshots of the data center structure is enormously costly in terms of resources and may also be imprecise given the rapid changes inherent in a data center. For example, snapshots every five minutes might be too infrequent, while snapshots every two minutes might be too costly. Generally speaking, these techniques are expensive and scale poorly.

### SUMMARY

Various deficiencies in the prior art are addressed by systems, methods, architectures, mechanisms and/or apparatus for determining a historic hierarchy of failure relationships associated with a historic event of interest and identifying, for the historic moment in time, higher-level objects/entities within a data center which, when failed, necessarily produce failure of corresponding lower-level objects/entities. This information is especially useful within the context of identifying root cause failures associated with a historic event of interest, as well as the impact of the historic event of interest upon other objects/entities.

For example, a method according to one embodiment comprises identifying a plurality of events temporally proximate a historic event of interest at a data center (DC), each of the historic event of interest and the plurality of events being associated with at least one contemporaneously existing DC entity; defining a hierarchy of failure relationships of the contemporaneously existing DC entities, each of the failure relationships comprising a higher-level entity and at least one corresponding lower level entity, each lower level entity necessarily failing in response to failure of a corresponding higher-level entity; and identifying, using the hierarchy of failure relationships of the contemporaneously existing DC entities, those DC entities in a failure relationships with the DC entity associated with the historic event of interest.

### BRIEF DESCRIPTION OF THE DRAWINGS

The teachings herein can be readily understood by considering the following detailed description in conjunction with the accompanying drawings, in which:

FIG. 1 depicts a high-level block diagram of a system benefiting from various embodiments;

FIG. 2 depicts an exemplary management system suitable for use in the system of FIG. 1;

FIG. 3 depicts a flow diagram of methods according to various embodiments;

FIG. 4 graphically depicts a hierarchy of failure relationships of DC entities supporting an exemplary virtualized service useful in understanding the embodiments;

FIG. 5 depicts a flow diagram of a method for determining one or more potential root causes of a historic event of interest;

FIG. 6 depicts a flow diagram of a correlation window adaptation method suitable for use in various embodiments; and

FIG. 7 depicts a high-level block diagram of a computing device suitable for use in performing the functions described herein.

To facilitate understanding, identical reference numerals have been used, where possible, to designate identical elements that are common to the figures.

### DETAILED DESCRIPTION OF THE INVENTION

The invention will be discussed within the context of systems, methods, architectures, mechanisms and/or apparatus for identifying historic hierarchical failure relationships of managed objects/entities at a data center to determine root cause failures associated with historic event of interest and/or determine historic or subsequent impact of the historic event of interest another objects/entities at the data center.

For example, given an event of interest in the past (e.g., a failure of a virtual entity or object of importance to a customer), the events temporally proximate the failure of interest (e.g., +/−some amount of time) are useful in determining a root cause of that event of interest.

First, for each temporally proximate event, the corresponding event log data indicative of the virtual object associated with the event, and the date indicative of the parent virtual object of that virtual object, is used to recreate a relation graph (failure graph) representing the virtual objects and protocols in existence at the time of the failure of interest.

Second, the recreated relation graph is used by the rules engine to process the historic event data (or some portion thereof) to identify thereby the root cause of the historic event of interest. That is, the recreated (historic) relation graph is used by the rules engine to process some portion of the stored events from the event logs to recreate the conditions associated with the failure or other event of interest such that the root cause of the failure or other event of interest can be established.

In various embodiments, the re-created relation graph is used by the rules engine to process the historic event data (or some portion thereof) to identify thereby the impact of the historic event of interest. That is, the re-created (historic) relation graph is used by the rules engine to process some portion of the stored events from the event logs to re-create the conditions associated with the failure or other event of interest such that the impact of the failure or other event of interest upon other objects/entities within the DC may be determined.

For example, a failure of a virtual switch supporting (i.e., hierarchically above) a number of virtual machines in a data center will result in the generation of alarms indicative of the failure of the virtual switch, the failure of each of the virtual machines, the failure of the virtual ports supported by the virtual machines and so on. Thus, the root cause of a failure of a virtual machine port may comprise a failure of the virtual machine associated with that report. Similarly, the impact of a failure of a virtual switch may comprise a failure of communication paths associated with a number of virtual machines.

However, it will be appreciated by those skilled in the art that the invention has broader applicability than described herein with respect to the various embodiments.

Virtualized services as discussed herein generally describe any type of virtualized compute and/or storage resources capable of being provided to a tenant. Moreover, virtualized services also include access to non-virtual appliances or other devices using virtualized compute/storage resources, data center network infrastructure and so on. The various embodiments are adapted to improve event-related processing within the context of data centers, networks and the like. The various embodiments advantageously improve such processing even as problems due to the nature of virtual machines, mixed virtual and real provisioning of VMs and the like make such processing more complex. Moreover, as data center sizes scale up the resources necessary to perform such correlation become enormous and the process cannot be handled in an efficient manner.

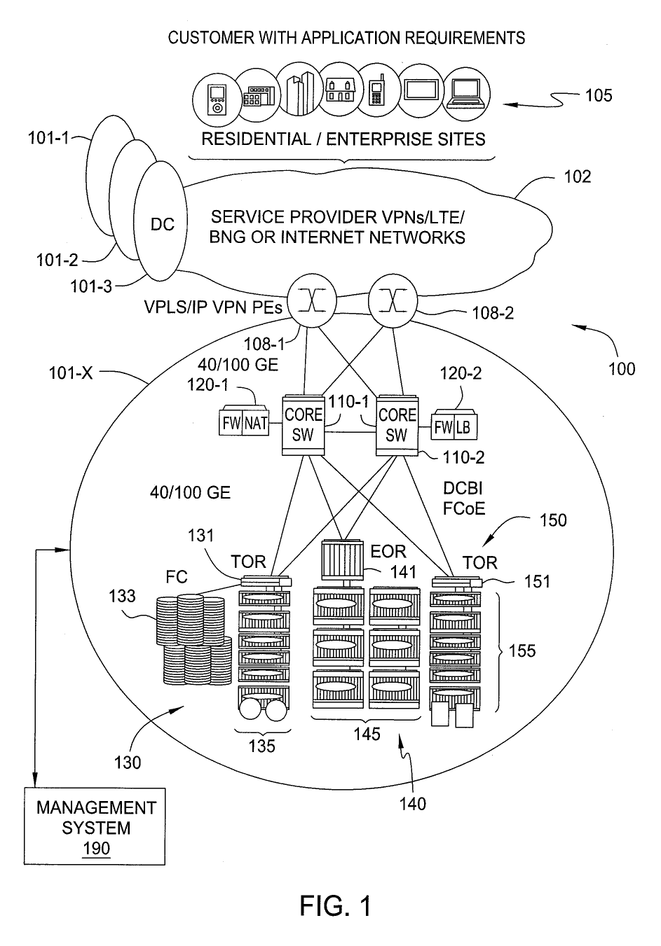

FIG. 1 depicts a high-level block diagram of a system benefiting from various embodiments. Specifically, FIG. 1 depicts a system 100 comprising a plurality of data centers (DC) 101-1 through 101-X (collectively data centers 101) operative to provide compute and storage resources to numerous customers having application requirements at residential and/or enterprise sites 105 via one or more networks 102.

The customers having application requirements at residential and/or enterprise sites 105 interact with the network 102 via any standard wireless or wireline access networks to enable local client devices (e.g., computers, mobile devices, set-top boxes (STBs), storage area network components, Customer Edge (CE) routers, access points and the like) to access virtualized compute and storage resources at one or more of the data centers 101.

The networks 102 may comprise any of a plurality of available access network and/or core network topologies and protocols, alone or in any combination, such as Virtual Private Networks (VPNs), Long Term Evolution (LTE), Border Network Gateway (BNG), Internet networks and the like.

The various embodiments will generally be described within the context of IP networks enabling communication between provider edge (PE) nodes 108. Each of the PE nodes 108 may support multiple data centers 101. That is, the two PE nodes 108-1 and 108-2 depicted in FIG. 1 as communicating between networks 102 and DC 101-X may also be used to support a plurality of other data centers 101.

The data center 101 (illustratively DC 101-X) is depicted as comprising a plurality of core switches 110, a plurality of service appliances 120, a first resource cluster 130, a second resource cluster 140, and a third resource cluster 150.

Each of, illustratively, two PE nodes 108-1 and 108-2 is connected to each of the, illustratively, two core switches 110-1 and 110-2. More or fewer PE nodes 108 and/or core switches 110 may be used; redundant or backup capability is typically desired. The PE routers 108 interconnect the DC 101 with the networks 102 and, thereby, other DCs 101 and end-users 105. The DC 101 is generally organized in cells, where each cell can support thousands of servers and virtual machines.

Each of the core switches 110-1 and 110-2 is associated with a respective (optional) service appliance 120-1 and 120-2. The service appliances 120 are used to provide higher layer networking functions such as providing firewalls, performing load balancing tasks and so on.

The resource clusters 130-150 are depicted as compute and/or storage resources organized as racks of servers implemented either by multi-server blade chassis or individual servers. Each rack holds a number of servers (depending on the architecture), and each server can support a number of processors. A set of network connections connect the servers with either a Top-of-Rack (ToR) or End-of-Rack (EoR) switch. While only three resource clusters 130-150 are shown herein, hundreds or thousands of resource clusters may be used. Moreover, the configuration of the depicted resource clusters is for illustrative purposes only; many more and varied resource cluster configurations are known to those skilled in the art. In addition, specific (i.e., non-clustered) resources may also be used to provide compute and/or storage resources within the context of DC 101.

Exemplary resource cluster 130 is depicted as including a ToR switch 131 in communication with a mass storage device(s) or storage area network (SAN) 133, as well as a plurality of server blades 135 adapted to support, illustratively, virtual machines (VMs). Exemplary resource cluster 140 is depicted as including an EoR switch 141 in communication with a plurality of discrete servers 145. Exemplary resource cluster 150 is depicted as including a ToR switch 151 in communication with a plurality of virtual switches 155 adapted to support, illustratively, the VM-based appliances.

In various embodiments, the ToR/EoR switches are connected directly to the PE routers 108. In various embodiments, the core or aggregation switches 120 are used to connect the ToR/EoR switches to the PE routers 108. In various embodiments, the core or aggregation switches 120 are used to interconnect the ToR/EoR switches. In various embodiments, direct connections may be made between some or all of the ToR/EoR switches.

A VirtualSwitch Control Module (VCM) running in the ToR switch gathers connectivity, routing, reachability and other control plane information from other routers and network elements inside and outside the DC. The VCM may run also on a VM located in a regular server. The VCM then programs each of the virtual switches with the specific routing information relevant to the virtual machines (VMs) associated with that virtual switch. This programming may be performed by updating L2 and/or L3 forwarding tables or other data structures within the virtual switches. In this manner, traffic received at a virtual switch is propagated from a virtual switch toward an appropriate next hop over a tunnel between the source hypervisor and destination hypervisor using an IP tunnel. The ToR switch performs just tunnel forwarding without being aware of the service addressing.

Generally speaking, the “end-users/customer edge equivalents” for the internal DC network comprise either VM or server blade hosts, service appliances and/or storage areas. Similarly, the data center gateway devices (e.g., PE servers 108) offer connectivity to the outside world; namely, Internet, VPNs (IP VPNs/VPLS/VPWS), other DC locations, Enterprise private network or (residential) subscriber deployments (BNG, Wireless (LTE etc), Cable) and so on.

In addition to the various elements and functions described above, the system 100 of FIG. 1 further includes a Management System (MS) 190. The MS 190 is adapted to support various management functions associated with the data center or, more generically, telecommunication network or computer network resources. The MS 190 is adapted to communicate with various portions of the system 100, such as one or more of the data centers 101. The MS 190 may also be adapted to communicate with other operations support systems (e.g., Element Management Systems (EMSs), Topology Management Systems (TMSs), and the like, as well as various combinations thereof).

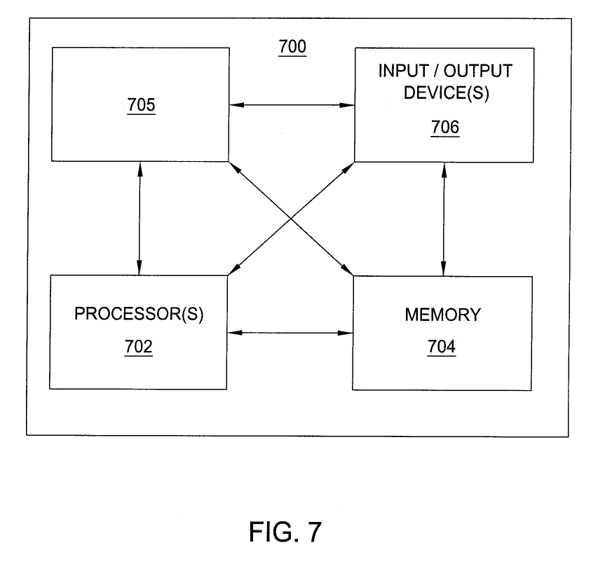

The MS 190 may be implemented at a network node, network operations center (NOC) or any other location capable of communication with the relevant portion of the system 100, such as a specific data center 101 and various elements related thereto. The MS 190 may be implemented as a general purpose computing device or specific purpose computing device, such as described below with respect to FIG. 7.

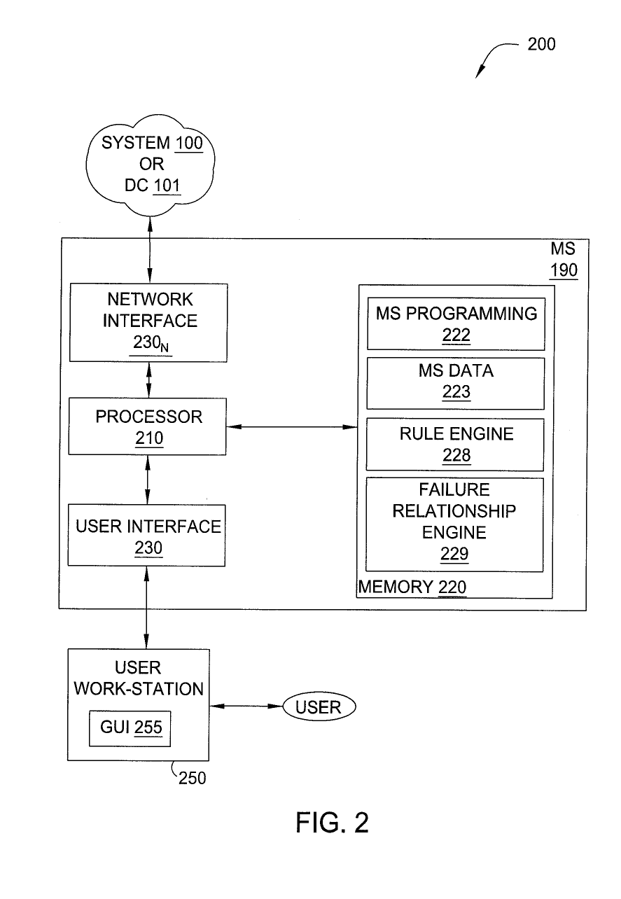

FIG. 2 depicts an exemplary management system suitable for use as the management system of FIG. 1. As depicted in FIG. 2, MS 190 includes one or more processor(s) 210, a memory 220, a network interface 230N, and a user interface 2301. The processor(s) 210 is coupled to each of the memory 220, the network interface 230N, and the user interface 2301.

The processor(s) 210 is adapted to cooperate with the memory 220, the network interface 230N, the user interface 2301, and the support circuits 240 to provide various management functions for a data center 101 and/or the system 100 of FIG. 1.

The memory 220, generally speaking, stores programs, data, tools and the like that are adapted for use in providing various management functions for the data center 101 and/or the system 100 of FIG. 1.

The memory 220 includes various management system (MS) programming modules 222 and MS databases 223 adapted to implement network management functionality such as discovering and maintaining network topology, processing VM related requests (e.g., instantiating, destroying, migrating and so on) and the like.

The memory 220 includes a rules engine 228 (e.g., DROOLS) operable to process historic events of virtualized and/or non-virtualized objects, entities, protocols and the like associated with the data center objects or entities within the data center against a data structure representing a hierarchical failure relationship of these objects or entities contemporaneous to the time of the event of interest to identify thereby root cause failures of the event of interest.

The memory 220 also includes a failure relationship engine 229 operable to construct a data structure or otherwise define the hierarchy of failure relationships in a manner suitable for use by the rules engine 228. Generally speaking, the hierarchy of failure relationships identifies hierarchically higher level objects, entities, protocols and the like which, upon failure, necessarily cause the failure of corresponding hierarchically lower level objects, entities, protocols and the like.

In various embodiments, the MS programming module 222, rules engine 228, failure relationship engine 229 are implemented using software instructions which may be executed by a processor (e.g., processor(s) 210) for performing the various management functions depicted and described herein.

The network interface 230N is adapted to facilitate communications with various network elements, nodes and other entities within the system 100, DC 101 or other network to support the management functions performed by MS 190.

The user interface 2301 is adapted to facilitate communications with one or more user workstations (illustratively, user workstation 250), for enabling one or more users to perform management functions for the system 100, DC 101 or other network.

As described herein, memory 220 includes the MS programming module 222, MS databases 223, rules engine 228 and failure relationship engine 229 which cooperate to provide the various functions depicted and described herein. Although primarily depicted and described herein with respect to specific functions being performed by and/or using specific ones of the engines and/or databases of memory 220, it will be appreciated that any of the management functions depicted and described herein may be performed by and/or using any one or more of the engines and/or databases of memory 220.

The MS programming 222 adapts the operation of the MS 140 to manage various network elements, DC elements and the like such as described above with respect to FIG. 1, as well as various other network elements (not shown) and/or various communication links there between. The MS databases 223 are used to store topology data, network element data, service related data, VM related data, BGP related data, IGP related data and any other data related to the operation of the Management System 190. The MS program 222 may implement various service aware manager (SAM) or network manager functions.

Events and Event Logs

Each virtual and nonvirtual object/entity generating events (i.e., each event source object/entity) communicate these events to the MS 190 or other entity via respective event streams. The MS 190 processes the event streams as described herein and, additionally, maintains an event log associated with each of the individual event stream sources. In various embodiments, combined event logs are maintained.

Each event log generally includes data fields providing, for each event, (1) a timestamp, (2) an event source object/entity identifier (3) any parent object/entity identifiers, (4) an event type indicator and other information as appropriate.

The timestamp is based upon the time the event was generated, the time the event was received and logged, or some other relevant timestamp criteria.

The event source object/entity identifier identifies the object/entity generating the event. The identifier may comprise, illustratively, a Universal Unique Identifier (UUID), an IP address or any other suitable identifier.

The parent object/entity identifiers identify any parent objects/entities associated with the event source object/entity. Specifically, most source objects/entities are associated with one or more parent objects/entities, wherein a failure of a parent object/entity necessarily results in a failure of any child object/entities. Thus, the parent object/entity identifiers identify those objects/entities in a failure relationship with the source object/entity, wherein the parent objects/entities comprise hierarchically higher level entities having failure relationships with the corresponding and hierarchically lower level source (i.e., child) entity.

Event type indicator indicates the type of event generated by the event source object/entity. Various types of events may be generated. For example, nonvirtual object/entity sourced events may comprise events such as UP, DOWN, SUSPEND, OFF-LINE, ON-LINE, FAIL, RESTORE, INITIALIZED and so on; virtual object/entity, virtual machine (VM) and VM-appliance sourced events may comprise events such as UP, DOWN, SUSPEND, STOP, CRASH, DESTROY, CREATE and so on; and IGP/BGP sourced events may comprise events such as New Prefix, Prefix withdrawn, Prefix Unreachable, Prefix Redundancy Changed and so on. Other examples will be known to those skilled in the art.

In various embodiments, each event source object/entity has knowledge of one or more respective parent objects/entities. In these embodiments, the event source object/entity includes parent object/entity identifiers within some or all of the events generated by the source object/entity.

In various embodiments, some or all of the event source objects/entities do not possess knowledge of respective parent objects/entities. However, current parent information for each of the event source objects/entities may be associated with each received event such that the parent information may be included within the event logs. The current parent information may be derived from provisioning information, stored correlation information and/or other management information. This information may be stored in, illustratively, the MS database 223 or other location.

Current Hierarchy of Failure Relationships

In various embodiments, current parent information for event source objects/entities may be retrieved or derived from information within a currently maintained hierarchy of failure relationships of some or all objects/entities within the DC.

The current hierarchy of failure relationships may be organized according to any of a number of data structures or formats, such as discussed in more detail herein. The current hierarchy of failure relationships, however organized, is substantially continually updated in response to changes in the state of the various real and/or virtual objects/entities within the DC, such as due to provisioning changes, object/event failures, object/event capability changes or service degradations and so on to provide thereby a relatively instantaneous or current “snapshot” of parent/child failure relationships of the various object/entities within the DC. Thus, the current hierarchy of failure relationships may be used to identify, for each event source object/entity, any corresponding parent objects/entities contemporaneously associated with an event source object/entity generating an event to be logged. This contemporaneous parent/child information may be included within the event log(s) associated with incoming events.

In various embodiments, the current hierarchy of failure relationships may be formed using a table of associations, using one or more directed trees, using a forest of directed trees forest of directed trees or using some other structure. The current hierarchy of failure relationships may be maintained by the failure relationship engine 229, MS programming 222 or other module within MS 190.

Thus, received events may be logged in a manner including event source object/entity identification along with corresponding parent object/entity information.

Reconstruction of Historic Hierarchy of Failure Relationships

In various embodiments, the rules engine 228 or other module within MS 190 correlates hierarchically related events in accordance with a relational graph or other structure indicative of failure relationships among event sources to identify thereby those failed higher-level objects or entities responsible for (or at least representative of) the various failed lower-level objects or entities. That is, parent/child failure relationship information stored in the various event logs may be used to reconstruct a hierarchy of failure relationships of various objects/entity in existence at some time in the past; namely, a time proximate to or contemporaneous with a historic event of interest. Further, by understanding the parent/child failure relationships of historic object/entities, the root cause and/or impact of the failure of a contemporaneous object/entity may be determined with varying degrees accuracy.

The accuracy of a determination of root cause or impact of a historical failure depends upon a number of candidate or potential root causes or impacts that may exist. If a single root cause of a historic event of interest is found, then it is likely that the single root cause is in fact the cause of that failure. If multiple potential/candidate root causes are found, then further analysis is provided to tiebreaker otherwise resolve one potential/candidate root cause as the most likely root cause of the historic event of interest.

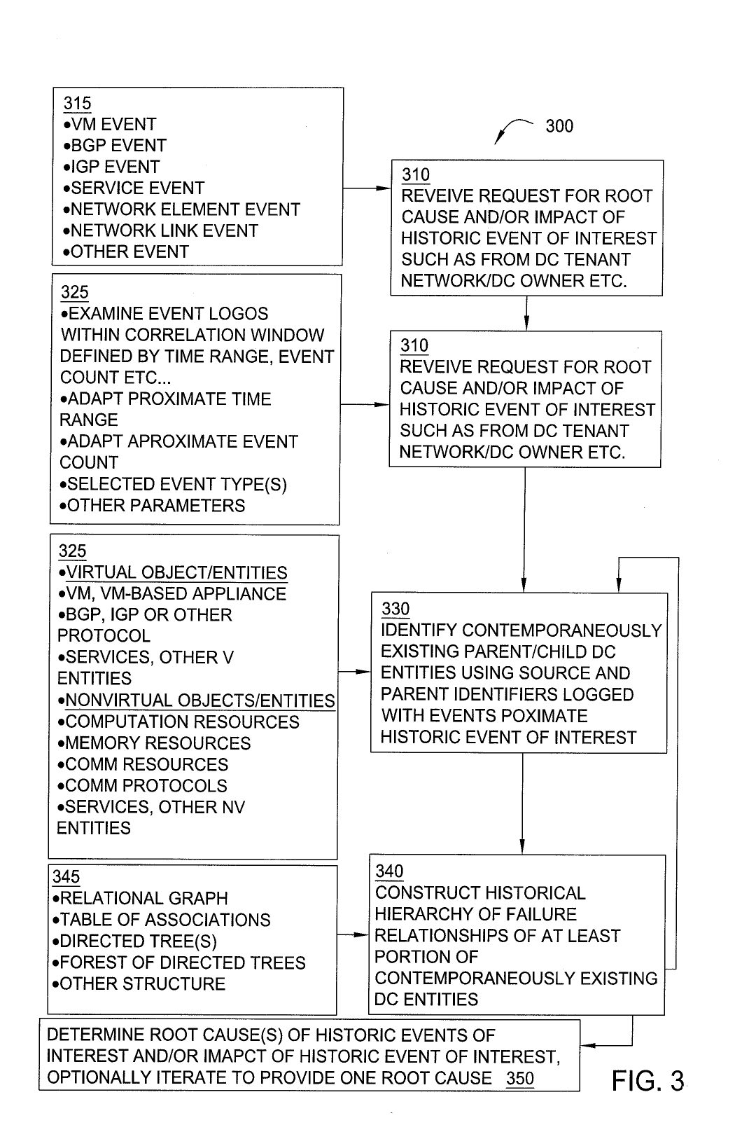

FIG. 3 depicts a flow diagram of a method according to one embodiment. Specifically, the method 300 of FIG. 3 contemplates various steps performed by, illustratively, the rules engine 228, failure relationship engine 229 and/or other MS programming mechanisms 222 associated with the management system 190. In various embodiments, the rules engine 228, failure relationship engine 229 and/or other MS programming mechanisms 222 are separate entities, partially combined or combined into a single functional module.

At step 310, the method 300 receives a request for a root cause analysis and or impact analysis pertaining to a historic event of interest from a DC tenant, DC owner, network owner, system operator or other entity. In various embodiments, personnel at a Network Operations Center (NOC) may access various program modules to provide historic event root cause analysis, historic event impact analysis and so on, such as within the context of managing a data center or network resources associated with a data center. Referring to box 315, the event correlation request may pertain to a specific VM event, BGP event, IGP event, service event, network element event, network link event or some other event.

At step 320, the method 300 identifies historic events proximate the historic event of interest. While the identified historic events may comprise failure events, warning events, status events and so on, failure events are especially useful in identifying root causes of historic failure events of interest. Referring to box 325, historic events proximate the historic event of interest may be identified by examining event logs within a predetermined or adaptive correlation window (CW) about and including the historic event of interest. The CW may defined by time range, event count or other parameter. Generally speaking, the identified historic events comprise those events generated by virtual and nonvirtual objects/entities existing within the data center proximate the time of the historic event of interest.

Optionally at step 320, the number of identified historic events may be decreased or increased as appropriate. The number of identified historic events may be decreased if sufficient accuracy in determining a root cause of the event of interest is achieved thereby, if specific types of events are more relevant and so on. Similarly, the number of identified historic events may be increased where more events or related information are helpful or necessary in converging upon a single root cause of the historic event of interest. Referring to box 325, the number of identified historic events may be adapted decreased or increased by adapting a proximate time range parameter associated with the CW, by adapting a proximate event count associated with the CW, by selecting one or more event types for inclusion or exclusion from consideration, and/or by modifying other parameters relevant to increasing or decreasing a number of identified historic events proximate the historic event of interest.

At step 330, the method 300 identifies contemporaneously existing parent/child DC object/entities using source identifiers and parent identifiers logged with events proximate the historic event of interest. Specifically, as previously noted, each logged event is associated with an event source object/entity and any parent object/entities corresponding to the source object/entity. Event source object/entity is explicit or implicitly defined by the received event. Parent objects/entities may be explicitly defined by the source object/entity via the generator event or they may be determined with respect to a current may be included within the event generated by the event source object/entity or derived from a currently maintained hierarchy of failure relationships at the time the event is received or logged.

Referring to box 335, virtual objects/entities may comprise virtual objects/entities such as virtual machines (VMs) or VM-based appliances, BGP/IGP or other protocols, user or supervisory services, or other virtual objects/entities. Similarly, nonvirtual objects/entities may comprise computation resources, memory resources, communication resources, communication protocols, user or supervisory services/implementations and other nonvirtual objects/entities.

At step 340, the method 300 constructs a relational graph or other data structure defining a historically relevant hierarchy of failure relationships of the various virtual and nonvirtual objects/entities within the data center identified at step 330; namely, the objects/entities existing at a time proximate the historic event of interest. Event data useful in identifying failure relationships may be found in various event logs such as those associated with the identified historic events of step 320 as well as, optionally, other historic events.

Referring to box 345, the hierarchy of failure relationships may be constructed using a relational graph, a table of association, one or more directed trees, a forest of directed trees, or some other data structure or representation mechanism. For example, a hierarchy of failure relationships may be constructed by plotting or positioning each entity and its corresponding parent entities in a directed tree data structure to build up a directed tree (or forest of directed trees) representing the failure hierarchy at the time of the event of interest.

Each event, temporally proximate or otherwise, has associated with it corresponding event log data indicative of the real or virtual object/entity associated with the event, the date of the event and so on. Further, event information provides data indicative of one or more objects/entities that are “parent” or hierarchically superior to the object/entity associated with the event. This information may be used to create a relation graph (failure graph) representing the virtual objects/entities, protocols and so one in existence at the time of the event or corresponding failure of interest.

Generally speaking, the identify the historic events proximate the historic event of interest (step 320), extract parent/child failure relationship information from the event logs associated with these historic events (step 330), and use the extracted parent/child failure relationship information to construct a historically relevant hierarchy of failure relationships including at least those failure relationships associated with the source object/entity of the historic event of interest at a time contemporaneous to the historic event of interest (step 340).

It will be appreciated that steps 330-340 may be iteratively performed for each identified historic event. That is, for each historic event proximate the historic event of interest identified at step 320, respective parent/child failure relationship information is extracted from the appropriate event log at step 330 and added to a historical hierarchy of failure relationships being constructed at step 340. For example, at step 340 respective parent/child failure relationship information may be used to provide corresponding graph vertices to a unidirected graph, relational graph, table of associations, directed tree and the like being created or recovered to provide thereby a historically/temporarily accurate hierarchy of failure relationships of the DC object/entities existing at the time of the historic event of interest.

Thus, even though over time both the virtual and nonvirtual provisioning of the DC changes, the parent/child failure relationship information within the various event logs is used to recover the historically/temporarily accurate hierarchy of failure relationships of the DC object/entities existing at the time of the historic event of interest. In this manner, the hierarchy of failure relationships current at the time of the historic event of interest is recovered or reconstructed.

At step 350, one or more potential root causes of the historic event of interest is determined and/or the impact of the historic event of interest is determined. That is, at step 350 various rules are applied by, illustratively, the rules engine 228 or other module to make such determinations.

In various embodiments, the root cause of a historic event of interest such as a failure event may comprise a failure of the DC object/entity associated with the historic event of interest or a failure of a corresponding higher-level DC objects/entity within the hierarchy of failure relationships. Similarly, a failure of the DC object/entity associated with the historic event of interest may result in the failure of other DC objects/entities.

As previously noted, accuracy of a determination of root cause or impact of a historical failure depends upon a number of candidate or potential root causes or impacts that may exist. With respect to potential/candidate root causes of a historic event, if a single root cause of a historic event of interest is found, then it is likely that the single root cause is in fact the cause of that failure.

In various embodiments, if multiple potential/candidate root causes are found, then further rules may be applied to break the tie or otherwise resolve one (or at least fewer) potential/candidate root cause as the most likely root cause of the historic event of interest. These rules may utilize additional information such as other provisioning information, other failure information, service provider or user information and the like, which information may be correlated with the event of interest, potential/candidate root causes of the event of interest and so on.

Impact analysis is slightly different than root cause analysis. Root cause analysis is directed to identifying a single root cause associated with an event of interest. However, impact analysis is directed to identifying all of the impacts of that event of interest. In either event, additional rules may be utilized to make such determinations.

In various embodiments, step 350 applies rules that adapt to multiple parent-child failure relationships. For example, such rules may resolve with varying degrees of certainty which of multiple parent object/entity failures resulted in the failure of a corresponding child object/entity having failure relationship with each of the multiple parent objects/entities. Various rules may also be used to address situations where hierarchically nested parent/child failure relationships exist, multiple parent/single child failure relationships exist, single parent/multiple child failure relationships exist, bidirectional failure relationships exist and any combination thereof.

Generally speaking, a hierarchy of failure relationships of objects/entities in existence at a time contemporaneous with the historic event of interest, and associated with failure events proximate the historic event of interest, may be used to determine a one or more root causes or potential root causes of the historic event of interest. That is, for those temporally relevant objects/entities deemed to be failed as indicated by a respective failure event proximate the historic event of interest, the relational graph or other data structure defining the hierarchy of failure relationships is used to correlate failed higher-level objects/entities to corresponding failed lower-level objects/entities, wherein one of the failed lower-level objects/entities comprises the object/entity associated with the historic event of interest.

In various embodiments, the root cause of the historic event of interest is determined by applying various rules to the historic event of interest and hierarchy of failure relationships to identify one or more DC objects/entities which may be the source or root cause of the historic event of interest.

Object/entities or other event sources may provide failure events, warning events, status events and so on. Of particular interest within the context of the various embodiments are failure events. Other embodiments may utilize failure events and warning events.

It will be noted that the various systems, methods, apparatus, mechanisms, techniques and the like described herein with respect to determining a root cause associated with a historic event of interest may be readily adapted to identify, for any event including a historic event of interest, the impact of the event upon other contemporaneously existing and/or subsequent DC objects/entities.

In one embodiment, upon determining the impact of a historic event of interest upon other objects/entities, automatic messages and/or automatic responses may be generated for DC/network service providers, tenants, customers, users and so on associated with an object/entity impacted by the historic event of interest.

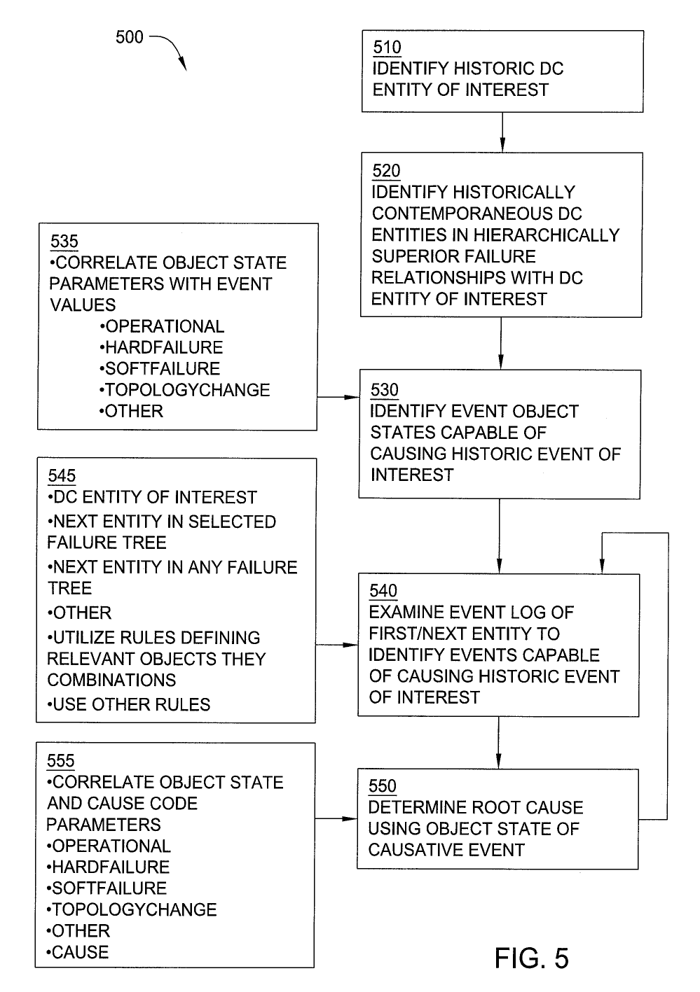

Therefore, in various embodiments, appropriate rules/mechanisms by which the rules engine or other processing entity or module may determine which of one of a plurality of potential root causes of a historic event of interest is the particular one root cause of that historic event of interest. An exemplary mechanism will be described below in more detail with respect to FIG. 5. Other mechanisms and variations thereof may be employed within the context of the various embodiments.

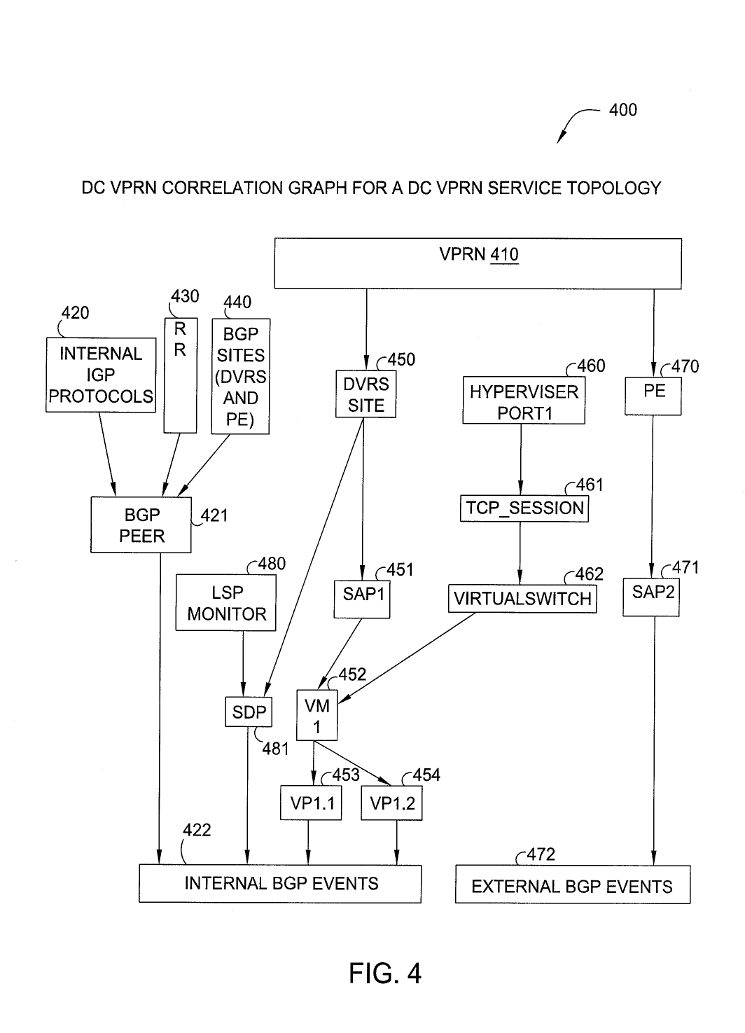

FIG. 4 graphically depicts hierarchy of failure relationships of DC entities supporting an exemplary virtualized service useful in understanding the embodiments. Specifically, FIG. 4 depicts virtual and nonvirtual DC objects/entities supporting a Virtual Private Routed Network (VPRN) service as well as the parent/child failure relationships between the various DC objects/entities.

Referring to FIG. 4, it can be seen that a top level VPRN service 410 is a higher-level object with respect to a DVRS site 450 and a provider edge (PE) router 470. PE router 470 is a higher-level object with respect to SAP2 471, which is a higher-level object with respect to external BGP unreachable events 472. DVRS site 450 is a higher-level object with respect to SAP1 451 and SDP 481, which is a higher-level object with respect to internal BGP unreachable events 422. Label Switched Path (LSP) monitor 480 is also a higher-level object with respect to Service Distribution Path (SDP) 481.

SAP1 451 is a higher-level object with respect to a first virtual machine (VM 1) 452, which is a higher-level object with respect to first virtual port (VP1.1) 453 and second virtual port (VP1.2) 454 of the first the end 452. Each of the first 453 and second 454 virtual ports are higher-level objects with respect to internal BGP unreachable events 422.

Internal Gateway Protocols (IGPs) 420, Route Reflectors (RR) 430 and Border Gateway Protocol (BGP) sites (e.g., DVRS and PE) 440 are all higher-level objects with respect to a BGP peer 421, which is a higher-level object with respect to internal BGP unreachable events 422.

A first hypervisor port 460 is a higher-level object with respect to a TCP session 461, which is a higher-level object with respect to a virtual switch 462, which is a higher-level object with respect to first VM 452.

Thus, FIG. 4 depicts the various parent/child failure relationships among a number of DC objects/entities forming an exemplary VPRN service 410. The failure of any object/entity representing a higher-level or parent object/entity in a failure relationship with one or more corresponding lower level or child objects/entities will necessarily result in the failure of the lower-level or child objects/entities. Further, it can be seen that multiple levels or tiers within a hierarchy of failure relationships are provided. Further, it can be seen that an object/entity may have failure relationships with one or more corresponding higher-level or parent objects/entities, one or more lower-level or child object/entities or any combination thereof.

The various embodiments described herein may be advantageously employed within the context of a number of applications such as the following, any of which may be implemented as a revenue generating application of a data center owner or service provider: (1) On-demand historic failure analysis; (2) Analysis of historic data to improve DC performance; (3) Analysis of historic data to improve customer experience or performance; (4) Analysis of historic data to enable customers to more precisely define necessary virtual resources, thereby avoiding waste and improving experience; and/or other applications.

FIG. 5 depicts a flow diagram of a method 500 for determining one or more potential root causes of a historic event of interest. Various embodiments of the method 500 of FIG. 5 are suitable for use in implementing step 350 as described above with respect to the method 300 of FIG. 3.

At step 510, the method 500 identifies the DC entity of interest. That is, the DC entity provisioned/instantiated at the time of the historic event of interest that, in fact, generated the historic event of interest is identified.

At step 520, the method 500 identifies those DC entities contemporaneous to the DC entity of interest that are in hierarchically superior failure relationships with the DC entity of interest. That is, using a historically relevant hierarchically of failure relationships including the DC entity of interest, those DC entities in a hierarchically superior failure relationship with the DC entity of interest are identified (i.e., those entities which, if failed, would necessarily cause failure of the entity of interest).

At step 530, the method 500 identifies event object states (i.e., event types/parameters) capable of causing historic event of interest. Referring to box 530, in various embodiments each event has associated with it various parameters or logic/object states which may be used to help determine root cause associated with a historic event of interest and, if desired, impact of that historic event of interest. For example, an object state parameter for an event may be defined to include any of the following values: (1) operational; (2) hardFailure (complete out-of-service state); (3) softFailure (partial failure or degradation of functionality); and (4) topologyChange. More, fewer and/or different values may be included within the correlation object state parameter.

At step 540, the method 500 examines the event log associated with a first or next DC entity identify therein any events having the object state capable of causing the historic event of interest. For example, if the event of interest reports object state as hardFailure, then searches for hardFailure and topologyChange object states on higher graph events (i.e., the event associated with hierarchically superior DC entities in failure relationship with DC entity of interest) are appropriate. In various embodiments, other types of events are ignored. It is noted that lower level objects cannot have hardFailure when higher objects are operational.

In various embodiments, rules are provided to define substantially all combinations of lower-level and higher-level object states in the graph. Other rules may be used in addition to or instead of these rules.

At step 550, the method 500 determines a root cause using object state information associated with a causative event identified at step 540. If no causative event was identified at step 540, and the method 500 repeats step 540 and 550.

In particular, at step 550 a correlation is made between an object state and a cause code associated with an event identified at step 540. For example, an object state may indicate that “BGP peer down” wherein a corresponding cause code may indicate that “configuration changed.”

Various rules may be applied to correlate numerous potential object state and cause code combinations.

Various rules may be applied to make decisions between multiple potential root cause failures. For example, a native object state (i.e., a state specific for an object) may be used in a tie-breaking procedure to identify a single one of several potential root cause failures as the specific root cause failure associated with the historic event of interest.

Various embodiments address the situation wherein multiple events of different types come from the same object, where the object is a potential for root cause. Each object may be associated with a list of event types, wherein an allocation of priority to each object and/or each event type is used to determine a root cause of the historic event of interest.

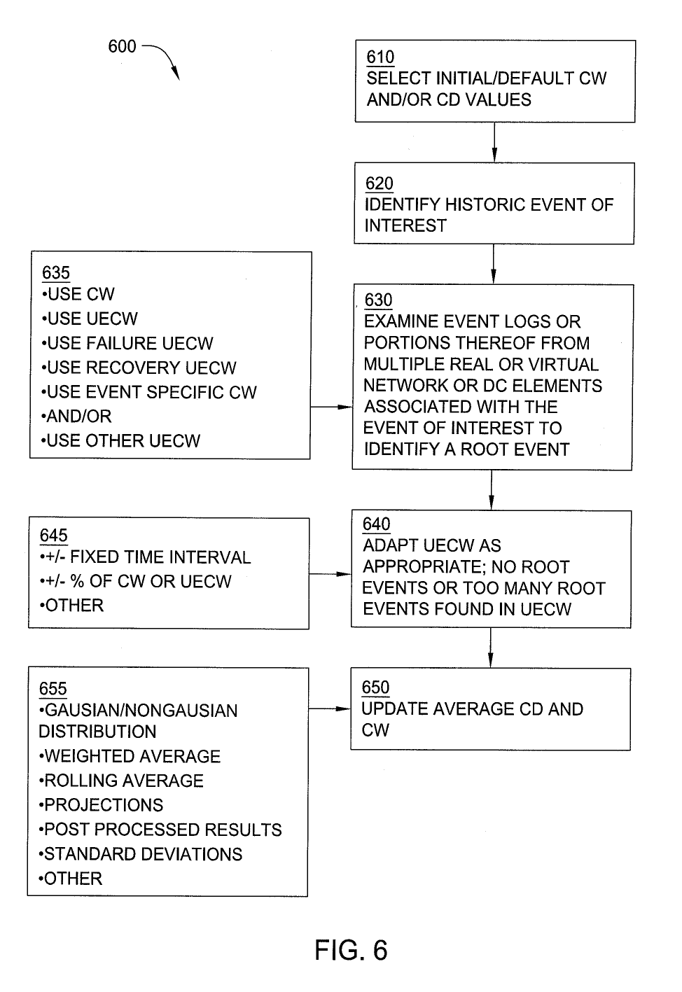

FIG. 6 depicts a flow diagram of a correlation window adaptation method suitable for use in various embodiments; Various embodiments of the method 600 of FIG. 6 are suitable for use in implementing step 320 as described above with respect to the method 300 of FIG. 3.

Generally speaking, the method 600 of FIG. 6 uses event log information associated with historic events temporally located within a correlation window (CW) proximate the event of interest to identify one or more events correlated with the historic event of interest that may comprise a root cause of the event of interest. Similarly, correlations between the historic event of interest and other events may be used to determine the impact of the event of interest upon other entities within the data center.

The method 600 operates to improve a correlation function by dynamically adjusting a period of time defined herein as a correlation window (CW) within which a correlated event pair including the event of interest exists. If more than one event may be correlated to the event of interest, then the correlation becomes ambiguous. In various embodiments, multiple root cause events may exist. For example, assume that the time around an event of interest comprises, illustratively, 10 seconds prior to and/or after an event of interest. However, the actual time between two correlated events may be much less than 10 seconds, the root cause event logged prior to the event of interest and so on. It should be noted that in this example 10 sec is a default CW, which may be increased or decreased as appropriate given the type of historic event of interest and likely causes of the historic event of interest.

For purposes of this discussion, a Correlation Window (CW) is defined as the time interval relative to a historic event of interest where a correlated root cause event most likely shall be found, while a Correlation Distance (CD) is defined as the time between the two correlated events. Different CW definitions are used within the context of different embodiments, such as by using various statistical techniques.

In some embodiments, the CW is defined as an Average CD±one CD Standard Deviation (or two SDs, or three SDs etc.). The average CD may be defined with respect to all of the events logged, some of the events logged, a predefined number of logged events, the logged events in a predefined period of time and so on. In essence, an average, rolling average or other sample of recent log events is used. The CD Standard Deviation may be calculated using the event log data. The standard deviation may contemplate a Gaussian distribution or any other distribution. Thus, a historic event of interest may be correlated with a later occurring or earlier occurring root cause event.

While generally described within the context of statistical averaging using Gaussian distributions, other statistical mechanisms may be used instead of, in addition to, or in any combination, including weighted average, rolling average, various projections, Gaussian distribution, non-Gaussian distribution, post processed results according to Gaussian or non-Gaussian distributions or standard deviations and so on.

At step 610, the method 600 begins operation by selecting initial/default CW and/or CD values. That is, an initial or default value for use as the correlation window (e.g., ±10 seconds) and/or the correlation distance (e.g., 5 seconds) is selected.

At step 620, the historic event of interest is identified, such as discussed with respect to step 310 and box 315 of the method 300 of FIG. 3.

At step 430, event logs or portions thereof associated with a specific time interval from multiple real or virtual network or DC elements associated with the historic event of interest are examined to identify thereby a potential or candidate root event or events. In the event of a single candidate root event, the historic event of interest is correlated with the single root event to provide thereby an unambiguous event pair. The amount of time between the event of interest and root event is determined as the correlation distance (CD) of the unambiguous event pair.

In various embodiments, multiple root events may be utilized in an average or otherwise statistically significant manner where either of the root events may in fact be a proximate cause of the event of interest. An event of interest may comprise an error or fail condition, or a recovery from an error or fail condition. However, the CD associated with a fault event may be different than the CD associated with a fault recovery event. That is, the time between a root cause event fault and a store the event of interest may be shorter than the time between a root cause event recovery and a corresponding recovery event associated with the stork event of interest. As such, various embodiments utilize an Unambiguous Event Correlation Window (UECW) to define the specific time interval within which to look for a root event.

Referring to box 635, the specific time interval within which a root event is to be identified may comprise the correlation window (CW) as described above, or a specific window selected for root cause identification purposes; namely, the UECW. Moreover, multiple UECWs may be used depending on the type of historic event of interest, such as a failure event UECW, a recovery event UECW, and event specific UECW and/or some other type of UECW.

At step 640, the UECW is adapted as appropriate such as when no corresponding root cause event is discovered or too many potential root cause events are discovered within time interval defined by the UECW. Referring to box 445, the UECW may be increased or decreased by a fixed interval, a percentage of the CW or UECW, or via some other means.

In various embodiments, if the UECW tends to provide ambiguous results (i.e., multiple potential correlated pairs), then the window is slightly decreased, while if the UECW tends to provide no results (i.e., no potential correlated pairs), then the window is slightly increased. This increase may be provided as an amount of time, a percentage of window size and so on. This incremental increase/decrease in UECW is provided automatically by the rules engine 228, MS programming 222 or other entity adapted to identify unambiguous event pairs.

At step 650, the correlation distance CD associated with the unambiguous event pair is used to recalculate/update an Average CD and recalculate the CW window used by the method 600. Referring to box 655, in various embodiments statistical averaging using Gaussian and non-Gaussian distributions, as well as other statistical mechanisms may be used instead of, in addition to, or in any combination with the above-described mechanisms, including weighted average, rolling average, various projections and the like, including post processed results according to Gaussian or non-Gaussian distributions or standard deviations and so on.

In various embodiments a rolling average of CDs is used such as an average of a finite number of previously identified unambiguous event pairs (e.g., 10, 20 100 or more), or a finite time period within which unambiguous event pairs have been identified (e.g., 1 minute, 10 minutes, 30 minutes, one hour and so on).

In various embodiments, a weighted average of CDs is used such as providing a greater weight to more recently identified unambiguous event pairs and/or giving different statistical weight to different types of event pairs based upon type of event of interest (e.g., fault events weighted more or less than recovery events) or other criteria.

The various steps described above with respect to the method 600 of FIG. 6 depicts an exemplary mechanism by which a rules engine 228 and/or MS programming 222 opportunistically adaptive update correlation distance, correlation window and/or other information suitable for use in determining a root cause associated with a store the event of interest.

FIG. 7 depicts a high-level block diagram of a computing device such as a used in a telecom or data center network element or management system, suitable for use in performing functions described herein. Specifically, the computing device 700 described herein is well adapted for implementing the various functions described above with respect to the various data center (DC) elements, network elements, nodes, routers, management entities and the like, as well as the methods/mechanisms described with respect to the various figures.

In various embodiments, a business rules management system (BRMS) such as Drools is used to process data center object/entity events or event streams in accordance with historic hierarchy of failure relationships of the event-sourcing objects or entities at the data center to identify thereby historic root cause failures of objects/entities. Specifically, a historic hierarchy of failure relationships identifies, for a particular moment in time, higher-level objects/entities within the data center which, when failed, necessarily produce failure of corresponding lower-level objects/entities. This information is especially useful within the context of identifying root cause failures associated with a historic event of interest, as well as the impact of the historic event of interest upon other objects/entities.

Multiple historic failure relationship hierarchies may be used to identify potential or actual root cause failures (or, conversely, the impact of the event of interest to other objects/entities) associated with failures or service degradations of interest to the system operator, client, user and so on. In various embodiments, the hierarchy of failure relationships is indicated using a relational graph. In various embodiments, the relational graph includes one or more trees.

As depicted in FIG. 7, computing device 700 includes a processor element 703 (e.g., a central processing unit (CPU) and/or other suitable processor(s)), a memory 704 (e.g., random access memory (RAM), read only memory (ROM), and the like), a cooperating module/process 705, and various input/output devices 706 (e.g., a user input device (such as a keyboard, a keypad, a mouse, and the like), a user output device (such as a display, a speaker, and the like), an input port, an output port, a receiver, a transmitter, and storage devices (e.g., a persistent solid state drive, a hard disk drive, a compact disk drive, and the like)).

It will be appreciated that the functions depicted and described herein may be implemented in hardware and/or in a combination of software and hardware, e.g., using a general purpose computer, one or more application specific integrated circuits (ASIC), and/or any other hardware equivalents. In one embodiment, the cooperating process 705 can be loaded into memory 704 and executed by processor 703 to implement the functions as discussed herein. Thus, cooperating process 705 (including associated data structures) can be stored on a computer readable storage medium, e.g., RAM memory, magnetic or optical drive or diskette, and the like.

It will be appreciated that computing device 700 depicted in FIG. 7 provides a general architecture and functionality suitable for implementing functional elements described herein or portions of the functional elements described herein.

It is contemplated that some of the steps discussed herein may be implemented within hardware, for example, as circuitry that cooperates with the processor to perform various method steps. Portions of the functions/elements described herein may be implemented as a computer program product wherein computer instructions, when processed by a computing device, adapt the operation of the computing device such that the methods and/or techniques described herein are invoked or otherwise provided. Instructions for invoking the inventive methods may be stored in tangible and non-transitory computer readable medium such as fixed or removable media or memory, and/or stored within a memory within a computing device operating according to the instructions.

Various modifications may be made to the systems, methods, apparatus, mechanisms, techniques and portions thereof described herein with respect to the various figures, such modifications being contemplated as being within the scope of the invention. For example, while a specific order of steps or arrangement of functional elements is presented in the various embodiments described herein, various other orders/arrangements of steps or functional elements may be utilized within the context of the various embodiments. Further, while modifications to embodiments may be discussed individually, various embodiments may use multiple modifications contemporaneously or in sequence, compound modifications and the like.

Although various embodiments which incorporate the teachings of the present invention have been shown and described in detail herein, those skilled in the art can readily devise many other varied embodiments that still incorporate these teachings. Thus, while the foregoing is directed to various embodiments of the present invention, other and further embodiments of the invention may be devised without departing from the basic scope thereof. As such, the appropriate scope of the invention is to be determined according to the claims.

What is claimed is:

1. A method, comprising:
identifying a plurality of events temporally proximate a historic event of interest at a data center (DC), each event having been generated by a respective source DC entity, each respective source DC entity having a failure relationship with at least one other contemporaneously existing DC entity, each of said failure relationships comprising a higher-level DC entity and a lower level DC entity, each lower level DC entity necessarily failing in response to failure of a corresponding higher-level DC entity;
defining a hierarchy of failure relationships of the source DC entities and other contemporaneously existing DC entities; and
identifying, using the hierarchy of failure relationships, those DC entities in a failure relationships with the DC entity associated with the historic event of interest.

2. The method of claim 1, wherein said steps of identifying and defining are iteratively performed for each of said plurality of events temporally proximate said historic event of interest.

3. The method of claim 1, wherein said identifying is performed using one or more event logs, where each line event is associated with a timestamp, a source DC entity identifier and at least one parent DC entity identifier.

4. The method of claim 3, wherein said source DC entity identifier identifies a lower level DC entity in a failure relationship with each of at least one higher-level parent DC entities.

5. The method of claim 1, further comprising:
selecting, using the hierarchy of failure relationships of the contemporaneously existing DC entities, any higher-level DC entities in a failure relationship with a corresponding lower level entity comprising the DC entity associated with the event of interest;
wherein a root cause of the historic event of interest comprises an event associated with at least one of the selected contemporaneously existing DC entities.

6. The method of claim 1, further comprising:
selecting, using the hierarchy of failure relationships of the contemporaneously existing DC entities, any lower-level DC entities in a failure relationship with a corresponding higher-level entity comprising the DC entity associated with the event of interest; and
determining an impact to said lower-level DC entities caused by said event of interest.

7. The method of claim 1, wherein at least one rule is applied to the selected contemporaneously existing DC entities to identify thereby the root cause of the historic failure event of interest.

8. The method of claim 7, wherein said at least one rule is used to determine which events associated with the selected contemporaneously existing DC entities are indicative of a condition capable of causing the historic event of interest.

9. The method of claim 4, wherein said at least one rule is used to determine which event associated with the selected contemporaneously existing DC entities are indicative of a root cause of the historic event of interest.

10. The method of claim 5, wherein the root cause of the historic event of interest is determined using events temporally proximate said historic event of interest associated with a selected higher-level DC entity in a failure relationship with a corresponding lower level entity comprising the DC entity associated with the event of interest.

11. The method of claim 5, wherein if only one higher-level DC entity is in a failure relationship having as a corresponding lower level DC entity the DC entity associated with the event of interest, that one higher-level DC entity is identified as the route cause entity.

12. The method of claim 5, wherein if only one higher-level DC entity is in a failure relationship having as a corresponding lower level DC entity the DC entity associated with the event of interest, an appropriate contemporaneous event associated with that one higher-level DC entity is identified as the route cause event.

13. The method of claim 5, wherein said plurality of events temporally proximate said event of interest comprises those events having timestamps within a correlation window (CW) associated with the event of interest.

14. The method of claim 13, further comprising:
in response to determining multiple potential root causes of the historic failure event, iteratively adapting a size of the CW and repeating the steps of identifying, defining and determining until only one potential root cause of the historic failure is determined.

15. The method of claim 5, wherein said event of interest is of a type having known correlations to other events, said step of identifying the plurality of events temporally proximate said event of interest comprising:
examining event log information within a correlation window (CW) temporally proximate the event of interest to identify one or more events correlated with said event of interest; and
in response to an occurrence of an unambiguous event pair, updating said CW using correlation distance (CD) information associated with said unambiguous event pair.

16. The method of claim 15, wherein said event of interest comprises a virtual machine (VM) event within a data center (DC), and said one or more events correlated with said event of interest comprise Border Gateway Protocol (BGP) events.

17. The method of claim 15, wherein said event of interest comprises a Border Gateway Protocol (BGP) within a data center (DC), and said one or more events correlated with said event of interest comprise virtual machine (VM) events.

18. The method of claim 17, wherein said CW is defined as
Average CD±one CD Standard Deviation.

19. The method of claim 5, wherein a root cause failed entity associated with the event of interest comprises a higher-level failed entity corresponding to lower-level failed entities including the selected entity associated with the event of interest.

20. The method of claim 1, wherein said hierarchy of failure relationships is represented as a relational graph.

21. The method of claim 20, wherein said relational graph is formed as a directed tree structure.

22. The method of claim 21, wherein a first directed tree represents a data center object failure hierarchy, a second directed tree represents a Border Gateway Protocol (BGP) failure hierarchy, and a third directed tree represents and Interior Gateway Protocol (IGP) failure hierarchy.

23. The method of claim 21, wherein the entities comprise data center objects, wherein a first directed tree represents a data center object hard failure hierarchy and a second directed tree represents a data center object soft failure hierarchy.

24. The method of claim 21, wherein the entities comprise Border Gateway Protocol (BGP) objects, wherein a first directed tree represents a BGP object hard failure hierarchy and a second directed tree represents a BGP object soft failure hierarchy.

25. The method of claim 1, wherein the selected contemporaneously existing DC entities comprise any of a virtual machine (VM), a VM-based appliance, a virtual router (VR) and a virtual service.

26. An apparatus for managing alarms at a data center, the apparatus comprising:
a processor configured for:
identifying a plurality of events temporally proximate a historic event of interest at a data center (DC), each event having been generated by a respective source DC entity, each respective source DC entity having a failure relationship with at least one other contemporaneously existing DC entity, each of said failure relationships comprising a higher-level DC entity and a lower level DC entity, each lower level DC entity necessarily failing in response to failure of a corresponding higher-level DC entity;
defining a hierarchy of failure relationships of the source DC entities and other contemporaneously existing DC entities; and
identifying, using the hierarchy of failure relationships, those DC entities in a failure relationships with the DC entity associated with the historic event of interest.

27. A tangible and non-transient computer readable storage medium storing instructions which, when executed by a computer, adapt the operation of the computer to perform a method for managing alarms at a data center, the method comprising:
identifying a plurality of events temporally proximate a historic event of interest at a data center (DC), each event having been generated by a respective source DC entity, each respective source DC entity having a failure relationship with at least one other contemporaneously existing DC entity, each of said failure relationships comprising a higher-level DC entity and a lower level DC entity, each lower level DC entity necessarily failing in response to failure of a corresponding higher-level DC entity;
defining a hierarchy of failure relationships of the source DC entities and other contemporaneously existing DC entities; and
identifying, using the hierarchy of failure relationships, those DC entities in a failure relationships with the DC entity associated with the historic event of interest.

28. A computer program product wherein computer instructions, when executed by a processor in a network element, adapt the operation of the network element to provide a method for managing alarms at a data center, the method comprising:
identifying a plurality of events temporally proximate a historic event of interest at a data center (DC), each event having been generated by a respective source DC entity, each respective source DC entity having a failure relationship with at least one other contemporaneously existing DC entity, each of said failure relationships comprising a higher-level DC entity and a lower level DC entity, each lower level DC entity necessarily failing in response to failure of a corresponding higher-level DC entity;
defining a hierarchy of failure relationships of the source DC entities and other contemporaneously existing DC entities; and
identifying, using the hierarchy of failure relationships, those DC entities in a failure relationships with the DC entity associated with the historic event of interest.
